(19) United States
(12) Patent Application Publication
(10) Pub. No.: US 2014/0172636 A1
(43) Pub. Date: Jun. 19, 2014

(54) IDENTIFICATION OF COUNTERFEIT GOODS

(71) Applicant: Hakan Bilal Kutlualp, Istanbul (TR)

(72) Inventor: Hakan Bilal Kutlualp, Istanbul (TR)

(73) Assignee: VERPROSYS GMBH, Krefeld (DE)

(21) Appl. No.: 14/131,953

(22) PCT Filed: Apr. 30, 2012
(86) PCT No.: PCT/EP2012/057882

§ 371 Date: Jan. 10, 2014

(30) Foreign Application Priority Data
Jul. 11, 2011 (DE) 10 2011 051 740.5

(51) Int. Cl. G06Q 30/00

(52) U.S. Cl. CPC G06Q 30/0185
USPC 705/26.35

(57) ABSTRACT

A method and system are provided for protecting against counterfeiting and for verifying a product using a concealed security code that is assigned to the product.

### DESCRIPTION

The invention relates to a method and a system for protecting against counterfeiting and for checking a product using a concealed security code assigned to the product.

In the case of spirits for example, there is the problem of bottles containing spirits being purchased from the catering trade and, after consumption, being easily filled with self-produced spirits. These are offered to the end customers and often result in poisoning. Furthermore, the financial authorities and thus the taxpayers in the affected states are cheated out of taxes.

Another problem is also that contract manufacturers who have been given an order to produce a particular product produce more products than agreed and contractually stipulated, deliver only the contractually stipulated quantity of products and then sell the excess products themselves.

The object of the present invention is therefore to provide a method and a system with which these disadvantages can be eliminated and counterfeit products, for example spirits, can be recognized not only by catering establishments but also by the final consumers of the goods and spirits, in particular.

The object on which the invention is based is achieved, in a first embodiment, by means of a method for protecting against counterfeiting and for checking a product using a concealed security code assigned to the product, wherein, in the method steps,
a) the concealed security code unique to the product is arranged on the product or its packaging and the uniquely concealed security code, in a product database on a server associated with a service provider, is assigned to a data record to which a unique product identifier has also already been assigned,
b) the concealed security code is exposed by a first querying party and is transmitted to the product database,
c) a check is carried out in the product database in order to determine whether this concealed security code has already been previously queried,
d) at least the result of the check from step c) is transmitted to the first querying party and the date of the check is assigned to the data record in the database,
e) the concealed security code exposed in step b) is transmitted by a further querying party to the database,
f) at least the information relating to when the exposed concealed security code was queried for the first time is transmitted to the further querying party, and the date of the further query is assigned to the data record in the database.

In the sense of the invention, the concealed security code unique to the product is a concealed security code which is not assigned to a second individual product of the same product type.

In the sense of the invention, a product identifier may be, for example, a unique number such as the EAN number or the designation of the product type.

The method according to the invention has the considerable advantage that an end consumer, as the further querying party, can easily find out when, for example, a bottle containing a spirit was queried for the first time in the database. Presumably, either the catering establishment or the first end consumer with the idea of exposing the concealed security code would query the database for the first time. An end consumer, as the further querying party, who finds out, as the result of the query, that the product, for example a bottle containing a spirit, was queried for the first time a year ago, for example, can presumably assume that this bottle has been refilled.

Another advantage of the method according to the invention is that the first querying party can find out whether the concealed security code is actually present in the database. If the concealed security code is namely not in the database, a counterfeit is certainly involved. If the first querying party who has exposed the security code finds out that the data record belonging to the exposed security code has already been marked as queried in the database, he can infer therefrom that either his own product is a counterfeit or at least one further product is in circulation as a counterfeit.

The database is preferably operated centrally by the service provider and does not have a decentralized structure. This has the advantage that the security-relevant and sensitive data have to be accordingly protected only in a single computation center, for example.

The concealment of the concealed security code may be selected, for example, from the group consisting of a scratch-off panel, a flap, perforated concealment, for example a perforated cover made of paper or cardboard, a sticker and a cap of a container for food or drinks. It is particularly preferably the cap of a bottle, with the result that the security code is concealed by the cap of a bottle and, in particular, by the screw closure of a bottle. This has the advantage that the security code cannot already be exposed in the shop and queried before purchasing the bottle, for example. For example, one part of the thread of the screw closure may be recessed in order to provide the security code there.

The method according to the invention is preferably characterized in that the technical functionality of the product is not restricted by the method. This has the advantage that the querying party himself can decide whether he would like to continue to use the product. This is because the method according to the invention is primarily used for consumer protection.

The security code may be selected from the group consisting of a sequence of alphanumeric characters, a sequence of numbers, a sequence of letters, a sequence of a combination of numbers and letters, a barcode, a one-dimensional code, a two-dimensional code, a three-dimensional code, a hologram and/or Braille. The security code may also be additionally provided in Braille.

After it has been exposed, the concealed security code can be transmitted by the querying party using different technical transmission possibilities selected from the group consisting of SMS, telephone, photo, Internet, mail, email and/or fax. For example, the security code may be photographed and transmitted using a mobile application installed on a mobile telephone. This variant would have the decisive advantage that the security of the entire method can be configured to be reliable by means of encryption, for example, in particular during transmission from the querying party to the database. Alternatively, the security code may also be photographed using a mobile telephone, for example, and can then be transmitted by email.

In step d) and, independently thereof, in step f), at least one or more items of information selected from the group consisting of the location of the querying party, previous number of queries, entire query history, date of the query, time of the query, user identifier of the querying party and/or product type are preferably transmitted to the manufacturer. As a result, the manufacturer can find out in a particularly simple manner how many counterfeits are probably in circulation at which locations. This was not possible with the previous technical solutions.

In step d) and/or, independently thereof, in step f), if no match is found when comparing the security code with the data records in the database, the information stating that the security code does not exist in the database is preferably also transmitted to the querying party as the possible result of the query. This had been rejected by previous technical solutions as disadvantageous since this would allegedly allow conclusions to be drawn on the lack of integrity of the system. However, the advantage which has previously clearly not been taken into consideration is that the querying party can find out that the queried product is very highly likely and almost certainly a counterfeit.

In step d), the information stating that the security code does not exist in the database or that the security code is queried for the first time or that the security code has already been previously queried is preferably transmitted to the first querying party as the result of the check from step c). Furthermore, the first querying party can also be informed of the product type, for example.

Alternatively or additionally, the concealed security code may also be arranged on a certificate or a document.

A further code is preferably arranged on the product or the packaging, which code is linked to the data record of the associated security code in the database, wherein the manufacturer of the product particularly preferably does not have access to the server containing the product database and the concealed security code is also not transmitted to the manufacturer of the product in any other way. This has the decisive advantage that the security code need not necessarily be interchanged with the manufacturer and the manufacturer can nevertheless use the method according to the invention by linking the security code to a further code in the database. The security code associated with the further code is, for example, that security code which is arranged, together with the further code, on the product or the packaging of the product. A decisive advantage of this feature is that a contract manufacturer who manufactures more of a particular product than instructed and would then like to put the “overproduction” on the market himself no longer has an opportunity to circumvent the method according to the invention.

The further code may be concealed or unconcealed. Irrespective of this, the further code is selected from the group consisting of a serial number, a sequence of alphanumeric characters, a sequence of numbers, a sequence of letters, a sequence of a combination of numbers and letters, a barcode, a one-dimensional code, a two-dimensional code, a three-dimensional code, a hologram and/or Braille. The further code may also additionally be provided in Braille. The length of the security code and/or of the further code is preferably at least 10 characters since otherwise there is the risk of it perhaps being input by a third party by chance.

There is preferably no technical interaction or other connection whatsoever between the concealed security code and the further code, in particular neither in a direct mathematical respect nor via an algorithm, for example an encryption algorithm. Such a connection was considered to be advantageous in the previous solutions. However, this connection has the decisive disadvantage that a contract manufacturer could draw conclusions on the security code using the further code. The advantage is therefore that a contract manufacturer has no opportunity whatsoever to be able to successfully guess the security code.

The method according to the invention is preferably characterized in that the further code is technically created by the manufacturer, is transmitted to the service provider and is assigned to the security code in the database. This has the decisive advantage that the manufacturer can independently determine his production figures and does not depend on the allocation of further codes by the service provider.

Together with the security code and/or the further code, the date of the first query and, particularly preferably, the query history are advantageously encrypted and are at least partially transmitted to a supervisory body. This supervisory body may be a state authority. For example, it may be the ministry of finance. This has the decisive advantage that tax-relevant products can be better supervised by the state and tax fraud can be very easily uncovered.

For example, in the method according to the invention, the concealed security code can be produced by the service provider or can be produced by this supervisory body and can be transmitted to the service provider. If the concealed security codes are produced by the service provider in the method according to the invention, they can also be transmitted to the supervisory body.

If it is determined, when querying the database, that the security code is not contained in the database, this result of the check can be transmitted to the supervisory body, for example, in the method according to the invention. Independently of this, if it is determined, when querying the database, that the security code has already been previously queried, this information can also be transmitted to the supervisory body.

During the query by the first querying party and/or the query by the further querying party, the information transmitted to the querying party preferably contains the further code and, in particular, does not contain the security code. As a result, by informing the querying party of the further code, the authenticity is confirmed by the response to the transmission of the security code to the database by the querying party. This considerably increases the security of the method according to the invention since a counterfeiter would not only have to guess the concealed security code but would also have to guess the further code assigned to this concealed security code. The further code is preferably transmitted to the querying party using different technical transmission possibilities selected from the group consisting of SMS, telephone, photo, Internet, mail, email and/or fax. The further code is particularly preferably transmitted to the querying party using the same technical possibility as the transmission of the security code by the querying party to the database.

The security code and/or possibly the further code is/are preferably arranged on a separate label or sticker on the product or its packaging. This separate label or the separate sticker, particularly preferably, cannot be removed or covered in a non-destructive manner and then exposed again. In this respect, the sticker or label may be configured, in particular, like a vignette for toll roads such as motorways.

During the query by the further querying party, information selected from the group consisting of product type, location, date and/or time for at least one previous query, in particular for a plurality of previous queries or for all previous queries, is preferably transmitted to the querying party. During the query by the further querying party, information selected from the group consisting of product type, location, date and/or time for at least one previous query, in particular for a plurality of previous queries or for all previous queries, is preferably transmitted to the querying party. As a result, the further querying party can estimate in a particularly simple manner whether the product is a counterfeit. A part of the query history or the entire query history for this specific security code is particularly preferably transmitted. For example, the information stating how often this security code has been queried since the first query is transmitted to the querying party.

If the querying party is informed, as the result, that the security code is not present in the database or has already been previously queried, the querying party can be given, for example, a telephone number to which he can turn in order to clarify whether the product is a copy or a refilled bottle containing spirits, for example. A call center may be set up for this purpose for the method according to the invention.

During the query by the first querying party and/or the query by the further querying party, the position of the querying party is preferably determined and is assigned to the data record in the database. This determination of the position of the querying party may be carried out, for example, by means of GPS, geo-localization of the IP address or by locating the radio cell of the mobile telephone belonging to the querying party. This has the advantage that the location of the copy or counterfeit can be easily determined and can be communicated to the manufacturer or the supervisory body, for example.

During the query by the first querying party and/or the query by the further querying party, a user identifier of the querying party is preferably determined and is assigned to the data record in the database. This user identifier may be, for example, the telephone number of the querying party, the IP address of the querying party or the username of the querying party in a social network, on a website or in a software application or a combination of these user identifiers.

The service provider preferably arranges the security code and/or possibly the further code on the separate label or sticker. The service provider produces, for example, the correspondingly printed labels or stickers. At least the security code thus need not be transmitted to the manufacturer. A leak for the sensitive information therefore cannot arise with the manufacturer or a third party. These labels or stickers are then sent to the manufacturer, for example, who can then arrange them on the product or the packaging, for example.

In order to avoid fraud, the frequency of queries for each querying party may be limited to one query per hour and per security code. In addition, the frequency of queries for each querying party can be limited to 50 queries per hour per technical transmission possibility. Furthermore, provision may be made for the security code and possibly the further code not to be produced as a serial number. For example, the minimum interval of time between two successive queries from a telephone number or an IP address can also be restricted to at least 30 seconds in order to avoid misuse of the system.

The product according to the invention or its packaging is preferably a drinks bottle. The method according to the invention has been found to be particularly advantageous for this purpose. This is because the concealed security code can be arranged in this case under the screw closure on the thread or in a recess in the thread, for example. As a result, the security code generally cannot be exposed before retail purchasing.

In order to increase the attractiveness of the method according to the invention among the querying parties, a raffle can take place among the queried codes. Furthermore, the stickers or labels may be provided with an advertising imprint, for example an advertising imprint from a sponsor, for example a football club.

In another embodiment, the object on which the invention is based is achieved by means of a system for protecting against counterfeiting and for checking a product using a concealed security code assigned to the product, which system is installed on one or more computers and comprises the following modules:
a) a query module which receives queries from querying parties,
b) a determination module which compares the transmitted query value with the security codes stored in the database,
c) an output module which transmits at least the following information to the querying party:
   i) in the event of the first query of the security code: that the security code is queried for the first time, or
   ii) in the event of the security code already having been previously queried: at least the time of the first query.

The query module is, for example, software on a computer linked to the telephone network, which software is able to read SMS using conventional means. This query module can thus receive the SMS messages transmitted by the querying parties and can extract the transmitted security code from the messages using conventional means.

The determination module is, for example, a software program which can look for the security code determined using the query module in the database and, if it can find a corresponding data record, determines the data fields associated with the data record and the values of said data fields.

The output module is, for example, software on a computer linked to the telephone network, which software is able to write SMS using conventional means. The output module may be installed on the same computer as the query module. The output module can then send the determined values of the data fields of the data record to the querying party as an SMS.

If the transmitted query value does not match a security code in the central memory, the information stating that the security code has not been assigned to a product or that the security code is not valid is preferably transmitted in the output module.

A code allocation module is preferably also provided in the system according to the invention, which module generates a security code which is unique to the product, so that this code can be attached to the product or its packaging in a concealed manner, and assigns the unique security code to a unique identification of the product in a central memory.

The invention is illustrated using the figures. It goes without saying that the figures are used only as an exemplary embodiment and do not restrict the scope of protection of the claims.

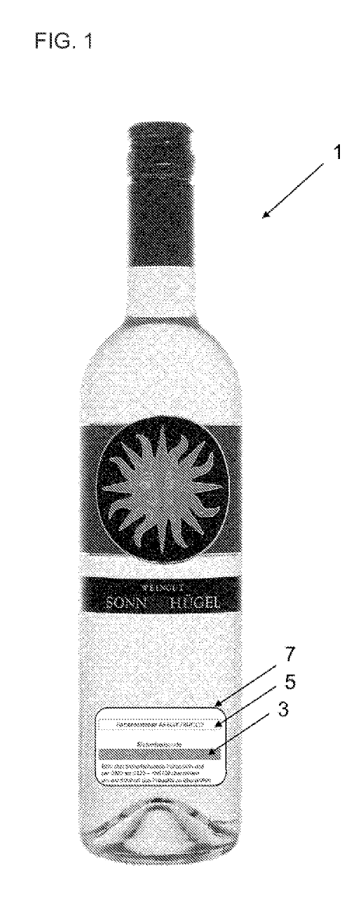

FIG. 1 shows a bottle for spirits to which a label is attached, on which a concealed security code under a scratch-off panel in the lower part of the label and a visible further code in the upper part of the label can be seen.

A supervisory body, such as the ministry of finance, or the service provider creates, for example, 5000 security codes which are possibly transmitted by the ministry of finance to the service provider. Data records are accordingly created in a database. Independently of this, a spirits manufacturer would like to produce 5000 bottles containing the spirits. The manufacturer thus generates 5000 serial numbers, which are not consecutive, and likewise transmits them to the service provider. The latter links these serial numbers in the data records to the security codes and additionally enters the information relating to the product type, for example “Yeni Raki Tekel, 45.0% vol., 0.70 liters”, in the respective data record. The service provider then produces 5000 labels to which the serial number is visibly applied as a further code and the associated security code is additionally applied under a scratch-off panel. These labels are sent to the manufacturer and are applied to the bottles by the manufacturer. FIG. 1 depicts a corresponding bottle.

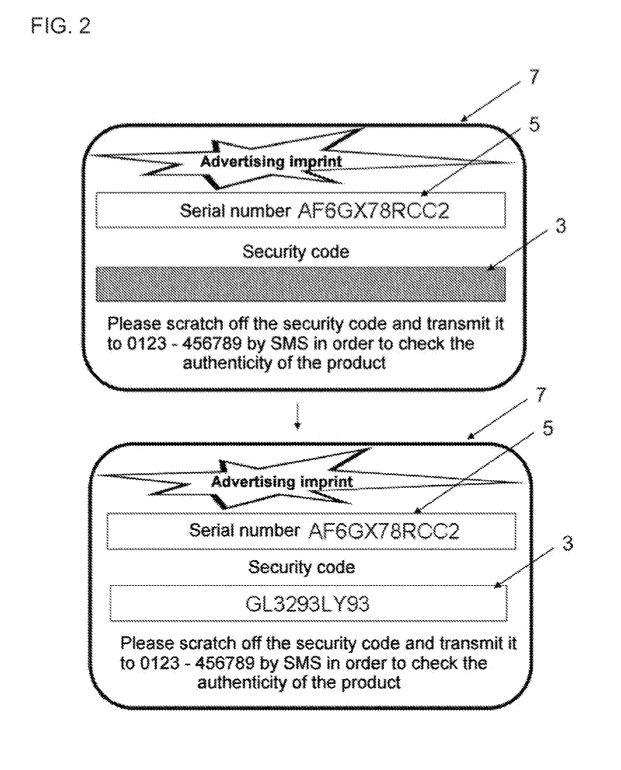

The upper part of FIG. 2 shows the label depicted in FIG. 1 in a close-up view and the lower part of FIG. 2 shows the same label after the security code has been exposed in the scratch-off panel.

The manufacturer delivers the 5000 bottles to the wholesale trade, for example, or else directly to the retail trade. The catering trade purchaser can then determine, after purchase, whether this bottle is authentic, for example by exposing the security code and querying the security code with the service provider.

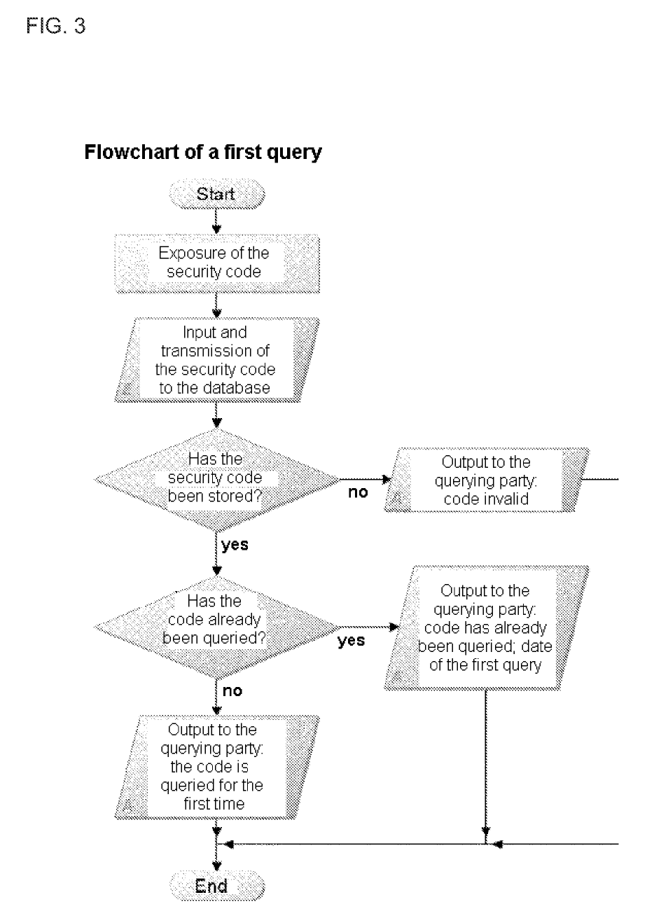

FIG. 3 illustrates, by way of example, such a first query, for example by the catering trade purchaser.

The purchaser forwards the exposed security code to the service provider and thus to the database, for example by SMS. A check is now carried out in the database in order to determine whether the transmitted security code is present in the database and has possibly already been previously queried.

The telephone number, the location of the one purchaser, which is approximately determined by means of the radio cell, and the date and time of the query are stored in the database for this data record if the security code can be found in the database.

The purchaser ideally receives the response, by SMS, that the security code has been queried by him for the first time and that the bottle is thus an original product. The purchaser additionally receives, as information, the serial number which he can compare with the serial number on the bottle.

If the security code cannot be found in the database, the purchaser is informed, by SMS, that the security code is invalid and that the product is a counterfeit.

If the security code has already been previously queried at least once in the database, the purchaser is informed, by SMS, that the security code has already been previously queried and is informed of the date and time and product type of the previous query. The purchaser additionally receives, as information, the serial number which he can compare with the serial number on the bottle. This information, together with the location of the one purchaser and the telephone number of the purchaser, is transmitted to the manufacturer and to the ministry of finance, for example. The manufacturer and ministry of finance can thus determine who has found counterfeits of the particular product at which location.

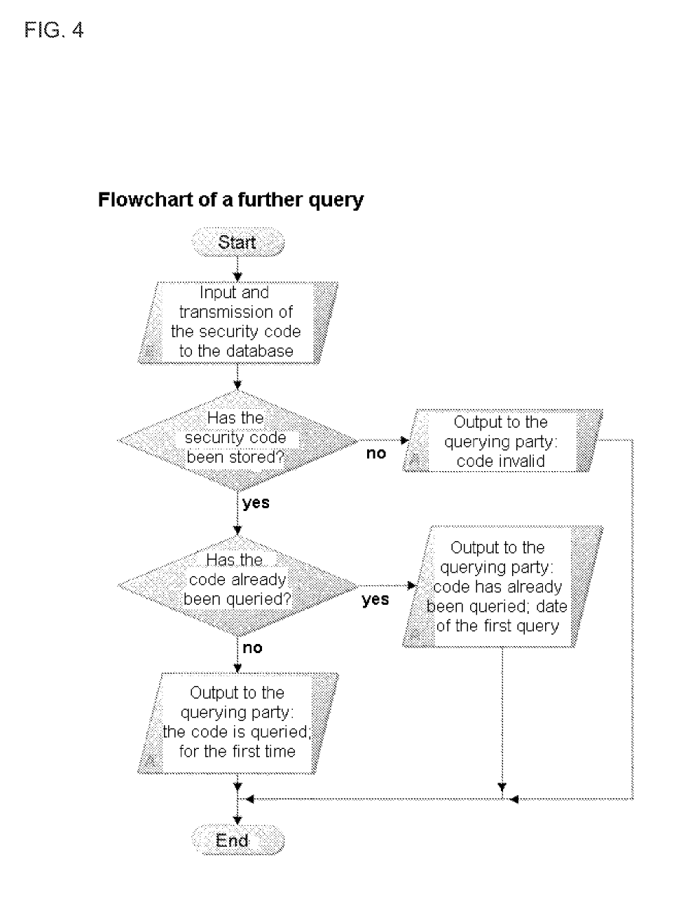

The bottles containing spirits are now consumed within a month in the catering establishment and are illegally filled by the catering establishment again, for example. Any customer of the catering establishment can now likewise transmit the exposed security code to the service provider and thus to the database by SMS, as diagrammatically illustrated in FIG. 4, and receives, as the response, for example, the information stating that the security code has already been queried 25 times within the last month and was queried for the first time exactly one month ago. This information, together with the location of the customer and the telephone number of the customer, is transmitted to the manufacturer and to the ministry of finance, for example. The manufacturer and the ministry of finance can thus determine who has found counterfeits of the particular product at which location. The customer can infer from the information transmitted to him that the bottle has already been illegally refilled and can decide not to drink the drink accordingly. The manufacturer can use the transmitted information to find out in a relatively simple manner where counterfeits of the products are put into circulation and possibly which sales channels are used to put these counterfeits on the market. The ministry of finance has the advantage of finding out where taxes are possibly evaded using counterfeit products.

### LIST OF REFERENCE SYMBOLS

1 Product, for example bottle containing spirits

3 Concealed security code

5 Further code, for example serial number

7 Label

1-10. (canceled)

11. A method for protecting against counterfeiting and for checking a product using a concealed security code assigned to the product, the method comprising:
arranging the concealed security code assigned to the product on the product or packaging of the product, wherein the concealed security code is assigned, in a product database on a server associated with a service provider, to a data record to which a product identifier of the product has previously been assigned;
exposing, by a first querying party, the concealed security code;
transmitting the concealed security code to the product database during a first query;
carrying out a check of the product database in order to determine whether the concealed security code has been previously queried;
transmitting at least a result of the check to the first querying party;
assigning a date of the first query to the data record in the database;
transmitting the concealed security code by a further querying party to the database during a further query;
transmitting at least information relating to when the concealed security code was queried for a first time to the further querying party; and
assigning a date of the further query to the data record in the database.

12. The method as claimed in claim 11, further comprising:
arranging a further code on the product or the packaging, wherein a manufacturer of the product does not have access to the server containing the product database, and wherein the concealed security code is not transmitted to the manufacturer of the product.

13. The method as claimed in claim 11, further comprising:
encrypting the concealed security code, the date of the first query, and a query history to yield an encryption result; and
at least partially transmitting the encryption result to a supervisory body.

14. The method as claimed in claim 12, further comprising:
encrypting the further code, the date of the first query, and a query history to yield an encryption result; and
at least partially transmitting the encryption result to a supervisory body.

15. The method as claimed in claim 12, wherein, for at least one of: the first query by the first querying party or the further query by the further querying party, the information transmitted to the querying party contains the further code and does not contain the security code.

16. The method as claimed in claim 11, wherein the concealed security code is arranged on a separate label or sticker on the product or the packaging, wherein the separate label or the separate sticker cannot be removed or covered in a non-destructive manner and then exposed again.

17. The method as claimed in claim 12, wherein the further code is arranged on a separate label or sticker on the product or the packaging, wherein the separate label or the separate sticker cannot be removed or covered in a non-destructive manner and then exposed again.

18. The method as claimed in claim 11, wherein, during the further query by the further querying party, information selected from at least one of the following: a product type, a location, or a time for at least one previous query, is transmitted to the further querying party.

19. The method as claimed in claim 18, wherein information for a plurality of previous queries or for all previous queries is transmitted to the further querying party.

20. The method as claimed in claim 11, wherein, during at least one of: the first query by the first querying party or the further query by the further querying party, a position of the querying party is determined and is assigned to the data record in the database.

21. The method as claimed in claim 11, wherein, during at least one of: the first query by the first querying party or the further query by the further querying party, a user identifier of the querying party is determined and is assigned to the data record in the database.

22. The method as claimed in claim 16, wherein the service provider arranges the concealed security code on the separate label or sticker.

23. The method as claimed in claim 17, wherein the service provider arranges the further code on the separate label or sticker.

24. A system for protecting against counterfeiting and for checking a product using a security code assigned to the product, the system comprising:
one or more computers on which is installed the following modules:
a query module which receives, from a querying party, a transmitted query value of the security code;
a determination module which compares the transmitted query value with stored security codes stored in a database;
an output module which performs at least one of the following:
i) in the event that the determination module determines that the transmitted query value is a first query of the security code, the output module transmits to the querying party that the security code is queried for the first time, or
ii) in the event that the determination module determines that the transmitted query value indicates that the security code has been previously queried, the output module transmits to the querying party at least a time of the first query.

25. The system as claimed in claim 24, further comprising:
a memory that stores the database having the stored security codes.

26. The system as claimed in claim 24, wherein the one or more computers further include:
a code allocation module that generates the security code assigned to the product.

27. The system as claimed in claim 24, further comprising:
a label or sticker on which the security code is arranged and concealed.

28. The system as claimed in claim 27, wherein the concealed security code on the label or sticker is concealed by a covering that is removable only once.

29. A non-transitory computer-readable medium storing software for protecting against counterfeiting and for checking a product using a security code assigned to the product, the software comprising:
executable code of a query module that receives, from a querying party, a transmitted query value of the security code;
executable code of a determination module that compares the transmitted query value with stored security codes stored in a database;
executable code of an output module that performs at least one of the following:
i) in the event that the determination module determines that the transmitted query value is a first query of the security code, the output module transmits to the querying party that the security code is queried for the first time, or
ii) in the event that the determination module determines that the transmitted query value indicates that the security code has been previously queried, the output module transmits to the querying party at least a time of the first query.

30. The non-transitory computer readable medium according to claim 29, wherein the software further comprises:
executable code of a code allocation module that generates the security code assigned to the product.
